(19) United States
(12) Patent Application Publication
(10) Pub. No.: US 2009/0311618 A1
(43) Pub. Date: Dec. 17, 2009

(54) Surface-modified non-magnetic mono-component color toner with improvements in background contamination and transfer efficiency and method of preparing the same

(76) Inventors: Chang-Soon Lee, Daejeon (KR); Hyeung-Jin Lee, Daejeon (KR); Je-Sik Jung, Jeollabuk-do (KR)

Correspondence Address: MCKENNA LONG & ALDRIDGE LLP, 1900 K STREET, NW, WASHINGTON, DC, 20006, US

(21) Appl. No.: 12/457,545

(22) Filed: Jun. 15, 2009

(30) Foreign Application Priority Data
Jun. 16, 2008 (KR) 10-2008-0056542

(51) Int. Cl. G03G 9/093; G03G 9/08; G03G 9/097; G03G 9/087; G03G 5/00

(52) U.S. Cl. 430/108.23; 430/110.2; 430/108.6; 430/108.4; 430/108.1; 430/108.3; 430/109.4; 430/109.5; 430/109.3; 430/137.11

(57) ABSTRACT

Provided is a non-magnetic mono-component color toner with improved charge properties by surface modification with a charge control agent. The color toner is prepared by spheroidizing toner core particles including a binder and a colorant in the presence of 0.5 to 3 parts by weight of a charge control agent and coating the resultant spherical toner core particles with a first spherical organic powder with an average particle size of 50 to 120 nm, a second spherical organic powder with an average particle size of 600 to 1,000 nm, silica with an average particle size of 5 to 20 nm, and titanium dioxide with an average particle size of 300 to 1,000 nm. The color toner exhibits excellent surface charge properties (e.g., a narrow charge distribution, high chargeability, and good charge maintenance capability), thereby ensuring low image/background contamination, high transfer efficiency, good image density and long-term stability.

### CROSS-REFERENCE TO RELATED PATENT APPLICATION

This application claims the benefit of Korean Patent Application No. 10-2008-0056542, filed on Jun. 16, 2008, in the Korean Intellectual Property Office, the disclosure of which is incorporated herein by reference.

### BACKGROUND OF THE INVENTION

1. Field of the Invention

The present invention relates to a non-magnetic mono-component color toner, and more particularly, to a non-magnetic mono-component color toner with improvements in background contamination and transfer efficiency, by spheroidizing toner core particles using a mechanical or thermal process in the presence of a charge control agent, thereby ensuring sufficient and uniform distribution of the charge control agent on surfaces of the toner core particles, and furthermore, by appropriately coating spherical inorganic powders with different particle sizes, thereby ensuring a narrow charge distribution, high chargeability, and good charge maintenance capability, and a method of preparing the toner.

2. Description of the Related Art

Recently, hard-copying and printing techniques using an image forming process such as electrophotography have rapidly advanced toward generating full-color images, instead of white-and-black images. In particular, there is a rapidly increasing demand on color printers. In a full-color electrophotographic image forming process, three color toners composed of cyan, magenta, and yellow, or four color toners composed of cyan, magenta, yellow, and black are generally used to achieve full-color images.

As such, rapidly emerging full-color technology is strongly required to satisfy the requirements such as high definition, high reliability; further, a small size, lightweight, a low cost, a high processing speed; and still further, low energy consumption and recyclability. In order to satisfy these requirements, many attempts have been made to improve an image forming method and a toner used therein.

Generally, an electrophotographic image forming apparatus performs an image forming method according to the following procedure: (1) charging a surface of a drum uniformly; (2) exposing the surface of the drum to light to create an electrostatic latent image; (3) supplying a toner of a developing roller onto the electrostatic latent image of the drum to form a toner image; (4) transferring the toner image to a transfer medium; (5) fixing the toner image on the transfer medium; and (6) removing a residual toner on the surface of the drum using a cleaning process.

In each process of such an electrophotographic image forming method, a toner is required to satisfy the following requirements.

That is, a toner should satisfy: an appropriate toner charge amount, good charge maintenance capability, good environmental stability; good transfer properties (in the process (4) for the transfer of the toner image); low-temperature fixing properties and offset resistance (in the process (5) for the fixation of the toner image); and good cleaning properties and anti-contamination properties (in the process (6) for the removal of the residual toner). In particular, recent progress in printing technology for high-definition, high-speed, and full-color image formation requires more detailed requirements for the above-described characteristics.

In addition, in order to guarantee good image durability during repeated printing, a process of converting an electrostatic latent image of a photosensitive drum to a toner image using toners of four colors has been proposed.

For more accurate color reproducibility, there has been used an indirect transfer-type image forming apparatus for primarily transferring a toner image on a surface of a photosensitive drum to an intermediate transfer medium so that the same colors are overlapped with each other and secondarily transferring the toner image on the intermediate transfer medium to a transfer medium. Such an indirect transfer-type image forming apparatus has been used mainly for full-color printers due to higher possibility of realizing high-speed and high-quality image formation.

Further, according to a recent high-speed printing trend, the same number of photosensitive drums as the number of colors is used, and a tandem-type developing process suitable for high-speed printing is widely used.

However, with respect to an indirect transfer-type image forming apparatus, a charged area of a photosensitive drum may be easily contaminated due to an increased number of transfer behaviors, thus making it difficult to achieve accurate transfer.

Tandem-type high-speed printing technology also has the above-described problems since it employs an indirect transfer process using a transfer belt.

In this regard, in order to create long-term stable, high-definition, full-color images, there is required a surface control technology of increasing a transfer efficiency onto a paper using a toner with high chargeability for improved charge stability and low adhesion to a photosensitive drum.

In the above-described transfer and cleaning processes, in order to avoid newly emerging unexpected problems, a toner is required to satisfy high chargeability and low adhesion to a photosensitive drum, thus preventing the deterioration of charge properties, and at the same time, to achieve high transfer efficiency of a developed image.

An image forming method using a toner containing peelable microparticles (e.g., silica) has been proposed to decrease an adhesion between the toner and a photosensitive drum. According to this method, microparticles such as silica are interposed between the toner and the drum to decrease an adhesion therebetween, thereby leading to improved transfer efficiency.

In this case, however, a coating amount of the microparticles on a surface of the toner should be set to a high level in order to achieve high transfer efficiency. Thus, there may arise problems such as an increased use of the microparticles, low toner chargeability, strong adhesion of the microparticles to an electrostatic latent image carrier, filming, or poor fixation. In particular, silica particles may cause problems such as image contamination under low-temperature and low-humidity ambient conditions and background contamination under high-temperature and high-humidity ambient conditions due to their high environment sensitivity.

In view of these problems, while searching for a more stable image formation method, the present inventors have found that when a charge control agent was added to toner core particles during spheroidization, the toner core particles were surface-modified to have a spherical shape and surface-composition suitable for achieving high chargeability and improved charge uniformity, and thus, even when a smaller amount of external additive microparticles was used, an addition effect thereof was sufficiently achieved, thereby avoiding problems such as image contamination and poor long-term reliability that may be caused by the use of an excess amount of microparticles, and thus, completed the present invention.

### SUMMARY OF THE INVENTION

The present invention provides a non-magnetic mono-component color toner that exhibits improved charge properties (e.g., high chargeability, good charge maintenance capability) and no image/background contamination, thereby achieving good image quality.

According to an aspect of the present invention, there is provided a non-magnetic mono-component color toner including spherical toner core particles surface-modified with a charge control agent.

The toner core particles may be further surface-coated with a first spherical organic powder with an average particle size of 50 to 120 nm; a second spherical organic powder with an average particle size of 600 to 1,000 nm; silica with an average particle size of 5 to 20 nm; and titanium dioxide with an average particle size of 300 to 1,000 nm.

The first spherical organic powder, the second spherical organic powder, the silica, and the titanium dioxide may be respectively used in an amount of 0.4 to 1.0 part by weight, 0.4 to 2.0 parts by weight, 1.0 to 4.0 parts by weight, and 1.5 to 4.0 parts by weight, based on 100 parts by weight of the toner core particles.

Each of the first and second spherical organic powders may be a polymer of at least one monomer selected from the group consisting of styrenes, vinyl halides, vinyl esters, methacrylates, acrylic acid derivatives, acrylates, and dienes.

The degree of spheroidization of the toner core particles may be 0.5 to 0.8.

The charge control agent may be selected from the group consisting of chromium-containing azo metal complexes, salicylate metal complexes, chromium-containing organic dyes, quaternary ammonium salts, and styrene acrylic resins.

The charge control agent may be selected from the group consisting of salicylate metal complexes and styrene acrylic resins.

The charge control agent may be used in an amount of 0.5 to 3.0 parts by weight, based on 100 parts by weight of the toner core particles.

The non-magnetic mono-component color toner may have an average particle size of 3-10 μm.

The toner core particles may include a binder resin and a colorant.

The binder resin may be at least one selected from the group consisting of polystyrene resins, polyester resins, polyethylene resins, polypropylene resins, styrene-alkyl acrylate copolymers, styrene-alkyl methacrylate copolymers, styrene-acrylonitrile copolymers, styrene-butadiene copolymers, and styrene-maleic acid copolymers.

The colorant may be at least one selected from the group consisting of nigrosine dye, aniline blue, charcoal blue, chrome yellow, ultramarine blue, Dupont oil red, methylene blue chloride, phthalocyanine blue, lamp black, rose bengal, C.I. pigment red 48:1, C.I. pigment red 48:4, C.I. pigment red 122, C.I. pigment red 57:1, C.I. pigment red 257, C.I. pigment red 296, C.I. pigment yellow 97, C.I. pigment yellow 12, C.I. pigment yellow 17, C.I. pigment yellow 14, C.I. pigment yellow 13, C.I. pigment yellow 16, C.I. pigment yellow 81, C.I. pigment yellow 126, C.I. pigment yellow 127, C.I. pigment blue 9, C.I. pigment blue 15, C.I. pigment blue 15:1, and C.I. pigment blue 15:3.

According to another aspect of the present invention, there is provided a method of preparing a non-magnetic mono-component color toner, the method including: spheroidizing toner core particles in the presence of a charge control agent; and coating the surfaces of the resultant spherical toner core particles with a first spherical organic powder with an average particle size of 50 to 120 nm, a second spherical organic powder with an average particle size of 600 to 1,000 nm, silica with an average particle size of 5 to 20 nm, and titanium dioxide with an average particle size of 300 to 1,000 nm.

The charge control agent may be used in an amount of 0.5 to 3.0 parts by weight, based on 100 parts by weight of the toner core particles.

The spheroidization of the toner core particles may be performed using a mechanical or thermal process.

### BRIEF DESCRIPTION OF THE DRAWINGS

The above and other features and advantages of the present invention will become more apparent by describing in detail exemplary embodiments thereof with reference to the attached drawing in which:

FIG. 1 is a diagram illustrating areas for measuring image densities on a sheet of paper.

### DETAILED DESCRIPTION OF THE INVENTION

Hereinafter, the present invention will be described in more detail.

The charge behavior of a toner is significantly affected by the surface composition of toner core particles, i.e., the amount and kind of a charge control agent present on a surface of the toner. The charge behavior of a toner is also affected by external additives. In order to achieve improved toner charge properties (e.g., high chargeability, long-term charge stability), it is necessary to prepare toner particles with a more sharp charge distribution by controlling the charge distribution of relatively slightly or excessively charged toner particles that are unavoidably generated during toner preparation. These objects have been accomplished by the present inventors through the surface modification of toner core particles using a high charge material, such as a charge control agent, during spheroidization of the core particles.

Thus, the present invention is characterized by surface modification of amorphous toner core particles using a charge control agent. The surface modification is intended for solving such problems that it is difficult to control the charge distribution of relatively slightly or excessively charged abnormal toner particles that are unavoidably generated during toner preparation, and to prevent the deterioration of developing properties that may be caused by these abnormal toner particles. That is, in view of the above problems, the present inventors have performed surface modification of toner core particles using a charge control agent, and demonstrated that a toner modified by such a surface modification exhibits improved charge properties (e.g., long-term stability, absolute charge-to-mass (Q/M) ratio), as compared with an unmodified toner.

As used herein, the expression “surface modification” refers an attachment of a charge control agent, which is added in a predetermined amount during spheroidization of toner core particles, onto the surfaces of the toner core particles. The charge properties of toner core particles can be slightly improved simply by a spheroidization process, but are not sufficient to obtain a high quality toner. Thus, the present inventors have achieved the surface modification of toner core particles by adding a charge control agent during spheroidization of the toner core particles.

A charge control agent may be classified into a resin type and a metal complex type. For example, the charge control agent may be a chromium-containing azo metal complex, a salicylate metal complex, a chromium-containing organic dye, a quaternary ammonium salt, a styrene acrylic resin, etc.

The degree of attachment of the charge control agent to the toner core particles is changed depending on the degree of spheroidization of the toner core particles. If the toner core particles are excessively spheroidized, many charge control agent particles may be buried in surfaces of the toner core particles, and thus, the addition effect of the charge control agent may be insufficient. In this regard, it is necessary to adjust the degree of spheroidization to an appropriate level.

The degree of spheroidization of the toner core particles may be defined as the ratio of the calculated value of the circumference of fully spherical toner core particles to the measured value of the circumference of actual toner core particles photographed with a scanning electron microscope (SEM), as follows.

Degree of spheroidization=(circumference of fully spherical toner core particles)/(circumference of actual toner core particles)

According to the degree of spheroidization defined above, toner core particles are spheroidized, and at the same time, surface-modified with a charge control agent. Such a surface modification of the toner core particles enables production of highly charged toner particles.

Preferably, the degree of spheroidization of the toner core particles may range from 0.5 to 0.8. If the degree of spheroidization exceeds 0.8, charge control agent particles may be buried in the toner core particles, instead of being attached onto surfaces of the toner core particles. On the other hand, if the degree of spheroidization is less than 0.5, amorphous toner particles may be formed, and charge control agent particles may be freely moved or slightly attached to surfaces of the toner core particles, due to poor surface modification, thereby deteriorating image characteristics.

Spherical toner core particles are obtained from amorphous toner core particles. The spheroidization of the toner core particles can be achieved by a thermal method or a mechanical method. According to the former method, spheroidization is performed by spraying toner core particles into a hot air flow, together with charge control agent particles. In this case, the agglomeration of toner core particles may occur, and the use of charge control agent particles with poor heat resistance may cause breakage of the particles. With respect to the latter method, fine powders may be generated. Such fine powders may disturb the attachment of the charge control agent particles onto the toner core particles or may contaminate constitutional elements of a printer, like other external additives, thus causing an adverse effect on images. In this regard, appropriate combination of the above-described spheroidization methods is required to achieve optimal effects.

Spherical toner core particles prepared as described above exhibit better developing properties than conventional amorphous toner particles. However, another embodiment of the present invention is to provide a toner with further improved charge properties (e.g., higher chargeability and more uniform charge distribution) by further adding organic and inorganic powders onto surfaces of the spherical toner core particles.

That is, the present inventors have planned external addition onto toner particles in order to reduce a frictional force between a sleeve and a doctor blade by external addition of different-sized spherical organic powders onto the spherical toner core particles, in order to improve charge properties by using further highly chargeable spherical powders, and in order to prevent an undesired surface change or contamination of toner particles that may be caused by frictional heat between the sleeve and the doctor blade during long-term use of the toner particles, thus ensuring improved long-term charge maintenance capability and long-term reliability of the toner particles by using different-sized powders.

The spherical organic powders are responsible for guaranteeing a uniform charge distribution, further improving the charge properties of spherical toner core particles (in case of using highly chargeable organic powders), and reducing a frictional force between a sleeve and a doctor blade. Meanwhile, conductive inorganic particles may lower the charge properties of toner core particles, thus adversely affecting a charge distribution during a transfer process. Such a problem can also be solved by the use of the spherical organic powders. With respect to the spherical organic powders with the above effects, different kinds of spherical organic powders having different particle sizes can be used to maximally increase these effects.

As such, the use of spherical organic powders with different particle sizes enables production of spherical toner particles with high chargeability and good charge maintenance capability through appropriate control of a frictional force between a sleeve and a doctor blade. Although a toner prepared as described above has high chargeability and good charge maintenance capability, it may have a broad charge distribution due to the presence of slightly or excessively charged toner particles, thereby causing poor transfer properties and background/marginal contamination. In view of the above problems about such image characteristics, the present inventors have found that the use of spherical titanium dioxide with a particle size of 300 to 1,000 nm enables achievement of a sharp charge distribution of toner particles, thereby preventing problems such as marginal contamination.

As described above, the surface-treatment of toner core particles with a charge control agent enables production of spherical toner core particles with a predetermined surface composition, and the spherical toner core particles may be further surface-treated with spherical organic powders having different particle sizes. The external addition of the spherical organic powders enables reduction of a frictional force and achievement of higher chargeability (in case of using highly chargeable organic powders) and long-term charge maintenance capability of toner particles. Further external addition of titanium dioxide particles enables production of a toner with a more sharp charge distribution. It is related to control of the charged state of reversely, slightly or excessively charged toner particles on the surface that cause various contaminations such as image or background contamination, thereby producing toner particles with a more appropriate charge distribution, thus ensuring uniform image characteristics with no image contamination.

A non-magnetic mono-component color toner according to the present invention may have an average particle size of 10 μm or less, preferably from 3 to 9 μm. If the average particle size of the toner is less than 3 μm, a contamination phenomenon may be markedly increased on non-image areas. On the other hand, if the average particle size of the toner exceeds 10 μm, an image resolution and a print yield may be lowered.

The toner core particles of non-magnetic mono-component color toner composition of the present invention include a binder resin and a colorant.

The binder resin may be an acrylic acid ester polymer such as polymethyl acrylate, polyethyl acrylate, polybutyl acrylate, poly(2-ethylhexyl acrylate), or polylauryl acrylate; a methacrylic acid ester polymer such as polymethyl methacrylate, polybutyl methacrylate, polyhexyl methacrylate, poly(2-ethylhexyl methacrylate), or polylauryl methacrylate; a copolymer of acrylic acid ester and methacrylic acid ester; a copolymer of a styrene monomer and acrylic acid ester/methacrylic acid ester; an ethylene-based polymer such as polyvinyl acetate, polyvinyl propionate, polyvinyl butyrate, polyethylene, or polypropylene, or a copolymer thereof; a styrene-based copolymer such as a styrene-butadiene copolymer, a styrene-isoprene copolymer, or a styrene-maleic acid copolymer; a polystyrene resin; a polyvinyl ether resin; a polyvinyl ketone resin; a polyester resin; a polyurethane resin; an epoxy resin; a silicone resin; or a combination of two or more. Preferably, the binder resin may be a polystyrene resin, a polyester resin, a polyethylene resin, a polypropylene resin, a styrene-alkyl acrylate copolymer, a styrene-alkyl methacrylate copolymer, a styrene-acrylonitrile copolymer, a styrene-butadiene copolymer, or a styrene-maleic acid copolymer.

The colorant may be carbon black, a magnetic component, a dye, or a pigment. For example, the colorant may be nigrosine dye, aniline blue, charcoal blue, chrome yellow, ultramarine blue, Dupont oil red, methylene blue chloride, phthalocyanine blue, lamp black, rose bengal, C.I. pigment red 48:1, C.I. pigment red 48:4, C.I. pigment red 122, C.I. pigment red 57:1, C.I. pigment red 257, C.I. pigment red 296, C.I. pigment yellow 97, C.I. pigment yellow 12, C.I. pigment yellow 17, C.I. pigment yellow 14, C.I. pigment yellow 13, C.I. pigment yellow 16, C.I. pigment yellow 81, C.I. pigment yellow 126, C.I. pigment yellow 127, C.I. pigment blue 9, C.I. pigment blue 15, C.I. pigment blue 15: 1, C.I. pigment blue 15:3, or the like.

The toner core particles may further include a release agent and a charge control agent.

The release agent may be generally a low molecular weight polyethylene or polypropylene wax, etc. The charge control agent may be a chromium-containing azo metal complex, a salicylate metal complex, a chromium-containing organic dye, a quaternary ammonium salt, a styrene acrylic resin, etc., as described above.

The inventive non-magnetic mono-component color toner composition may further include different kinds of spherical organic powders with different average particle sizes, e.g., two kinds of spherical organic powders with average particle sizes, i.e. 50 to 120 nm and 600 to 1,000 nm. Toner particles coated with spherical organic powders, such as highly chargeable PTFE (polytetrafluoroethylene) or PMMA (polymethylmethacrylate), do not have an adverse effect on their chargeability even when a printing process is repeated for a long time. In this regard, two kinds of spherical organic powders may be used in amounts of 0.4 to 1.0 part by weight and 0.4 to 2.0 parts by weight, based on 100 parts by weight of the toner core particles. If the contents of the spherical organic powders are less than 0.4 parts by weight, an addition effect thereof may be insufficient. On the other hand, if the contents of the spherical organic powders exceed 1 and 2 parts by weight, primary charge roller (PCR) contamination may occur or toner chargeability may be lowered, thereby leading to failure of high charging of toner particles.

The inventive non-magnetic mono-component color toner composition may further include silica with an average particle size of 5 to 20 nm. Silica particles with an average particle size of less than 5 nm may be embedded in surfaces of toner particles, and toner particles may be agglomerated due to a peeling phenomenon of the toner particles, thereby adversely affecting toner chargeability. On the other hand, silica particles with an average particle size of greater than 20 nm may not be sufficiently coated on toner particles, and may inefficiently serve as a flow agent, thereby lowering the flowability of the toner particles. Therefore, during actual use, even when a sufficient toner is present in a cartridge, a toner exchange signal may be detected. In this regard, it is preferable to adjust the average particle size of the silica particles to a range of 5 to 20 nm. If the content of the silica particles is less than 1.0 part by weight based on 100 parts by weight of the toner core particles, the function as a flow agent may be insufficient. On the other hand, if the content of silica particles exceeds 4.0 parts by weight, fixing properties may be lowered. In this regard, it is preferable to use the silica particles in an amount of 1.0 to 4.0 parts by weight based on 100 parts by weight of the toner core particles.

There are various kinds of titanium dioxide particles, but rutile-phase titanium dioxide particles are more effective than anatase-phase titanium dioxide particles. The titanium dioxide particles are responsible for maintaining a sharp toner charge distribution, i.e., controlling the charge distribution of reversely, slightly or excessively charged toner particles, so that contamination such as marginal or background contamination caused by such toner particles does not occur during long-term printing, thereby achieving image uniformity

In order to achieve the above functions, the titanium dioxide particles may have an average particle size of 300 to 1,000 nm. If the average particle size of the titanium dioxide particles exceeds 1,000 nm, their attachment to surfaces of the toner particles may be poor. On the other hand, if the average particle size of the titanium dioxide particles is less than 300 nm, a charge distribution control capability may be lowered, thereby making a charge distribution non-uniform. The titanium dioxide particles may be used in an amount of 1.5 to 4.0 parts by weight, based on 100 parts by weight of the toner core particles. If the content of the titanium dioxide particles is less than 1.5 parts by weight, an addition effect thereof may be insufficient. On the other hand, if the content of the titanium dioxide particles exceeds 4.0 parts by weight, poor coating may occur, and in some cases, damage (e.g. scratch) to a surface of a photosensitive drum may be caused, thus leading to a risk of another contamination.

As described above, the inventive non-magnetic mono-component color toner can be efficiently used in indirect transfer-type or tandem-type high-speed color printers which have been widely used according recent trends of full-color and high-speed printing.

Hereinafter, the present invention will be described more specifically by Examples. However, the following Examples are provided only for illustrations and thus the present invention is not limited thereto.

### EXAMPLE 1

<1-1> Preparation of Magenta Toner Core Particles

92 parts by weight of a polyester resin (M.W.: 2.5×10⁴), 5 parts by weight of quinacridone Red 122, 5 parts by weight of styrene acrylate used as a resin type charge control agent (CCA), and 2 parts by weight of low molecular weight polypropylene were mixed in a Henschel mixer. The resulting mixture was melted and kneaded at 155□ by means of a twin-screw melt kneader, ground into fine particles using a Jet mill pulverizer, and classified with an air jet classifier to obtain toner core particles with a volume average particle size of 8.0 μm.

<1-2> Preparation of Spherical Toner Particles

Toner core particles can be spheroidized through mechanical or thermal surface modification. In this Example, the toner core particles prepared in <1-1> were mechanically spheroidized using 2 parts by weight of styrene acrylate as a resin type CCA. At this time, the spheroidization was performed at 8000 rpm for 10 minutes so that the degree of the spheroidization was about 0.7.

<1-3> Preparation of Non-Magnetic Mono-Component Color Toner Particles

For surface coating of the spherical toner particles prepared in <1-2>, 100 parts by weight of the toner particles prepared in <1-2> was injected into a hybridizer, and 0.5 parts by weight of polymethylmethacrylate (PMMA) powder with an average particle size of 0.1 μm, 1.0 part by weight of PMMA powder with an average particle size of 0.8 μm, 1.2 parts by weight of octylsilane-modified silica powder with an average particle size of 6 nm, and 3.0 parts by weight of rutile-phase titanium dioxide (TiO₂) with an average particle size of 0.9 μm were then added thereto. The resultant mixture was stirred at 5,000 rpm for five minutes to give final color toner particles.

### EXAMPLES 2˜64

Non-magnetic mono-component color toners were prepared in the same manner as in Example 1 except by spheriodizing with charge control agent(surface modification), and then coating with spherical organic powders, silica, and titanium dioxide described in Table 1 below.

TABLE 1

| | Degree of | | First spherical organic powder | | |
|---|---|---|---|---|---|
| Section | spheroidization | CCA | Second spherical organic powder | Silica | TiO₂ |
| Example 2 | 0.6 | SA | 60 nm PMMA powder 0.8 pbw | 6 nm Silica | 500 nm TiO₂ |
| | | 0.5 pbw | 800 nm PMMA powder 1.5 pbw | 2.5 pbw | 4.0 pbw |
| Example 3 | 0.6 | SA | 60 nm PMMA powder 0.8 pbw | 6 nm Silica | 800 nm TiO₂ |
| | | 0.5 pbw | 800 nm PMMA powder 1.5 pbw | 2.5 pbw | 2.0 pbw |
| Example 4 | 0.6 | SA | 60 nm PMMA powder 0.8 pbw | 6 nm Silica | 800 nm TiO₂ |
| | | 0.5 pbw | 800 nm PMMA powder 1.5 pbw | 2.5 pbw | 4.0 pbw |
| Example 5 | 0.6 | SA | 60 nm PMMA powder 0.8 pbw | 16 nm Silica | 500 nm TiO₂ |
| | | 1.0 pbw | 800 nm PMMA powder 1.5 pbw | 2.5 pbw | 2.0 pbw |
| Example 6 | 0.6 | SA | 60 nm PMMA powder 0.8 pbw | 16 nm Silica | 500 nm TiO₂ |
| | | 1.0 pbw | 800 nm PMMA powder 1.5 pbw | 2.5 pbw | 4.0 pbw |
| Example 7 | 0.6 | SA | 60 nm PMMA powder 0.8 pbw | 16 nm Silica | 800 nm TiO₂ |
| | | 1.0 pbw | 800 nm PMMA powder 1.5 pbw | 2.5 pbw | 2.0 pbw |
| Example 8 | 0.6 | SA | 60 nm PMMA powder 0.8 pbw | 16 nm Silica | 800 nm TiO₂ |
| | | 1.5 pbw | 800 nm PMMA powder 1.5 pbw | 2.5 pbw | 4.0 pbw |
| Example 9 | 0.6 | SA | 60 nm PMMA powder 0.8 pbw | 6 nm Silica | 500 nm TiO₂ |
| | | 1.5 pbw | 800 nm PMMA powder 1.5 pbw | 3.5 pbw | 2.0 pbw |
| Example 10 | 0.6 | SA | 60 nm PMMA powder 0.8 pbw | 6 nm Silica | 500 nm TiO₂ |
| | | 1.5 pbw | 800 nm PMMA powder 1.5 pbw | 3.5 pbw | 4.0 pbw |
| Example 11 | 0.6 | SA | 60 nm PMMA powder 0.8 pbw | 6 nm Silica | 800 nm TiO₂ |
| | | 2.0 pbw | 800 nm PMMA powder 1.5 pbw | 3.5 pbw | 2.0 pbw |
| Example 12 | 0.6 | SA | 60 nm PMMA powder 0.8 pbw | 6 nm Silica | 800 nm TiO₂ |
| | | 2.0 pbw | 800 nm PMMA powder 1.5 pbw | 3.5 pbw | 4.0 pbw |
| Example 13 | 0.6 | SA | 60 nm PMMA powder 0.8 pbw | 16 nm Silica | 500 nm TiO₂ |
| | | 2.0 pbw | 800 nm PMMA powder 1.5 pbw | 3.5 pbw | 2.0 pbw |
| Example 14 | 0.6 | SA | 60 nm PMMA powder 0.8 pbw | 16 nm Silica | 500 nm TiO₂ |
| | | 2.0 pbw | 800 nm PMMA powder 1.5 pbw | 3.5 pbw | 4.0 pbw |
| Example 15 | 0.6 | SA | 60 nm PMMA powder 0.8 pbw | 16 nm Silica | 800 nm TiO₂ |
| | | 2.5 pbw | 800 nm PMMA powder 1.5 pbw | 3.5 pbw | 2.0 pbw |
| Example 16 | 0.6 | SA | 60 nm PMMA powder 0.8 pbw | 16 nm Silica | 800 nm TiO₂ |
| | | 2.5 pbw | 800 nm PMMA powder 1.5 pbw | 3.5 pbw | 4.0 pbw |
| Example 17 | 0.8 | SA | 100 nm PTFE powder 0.5 pbw | 6 nm Silica | 500 nm TiO₂ |
| | | 2.5 pbw | 900 nm PTFE powder 0.5 pbw | 2.5 pbw | 2.0 pbw |
| Example 18 | 0.8 | SA | 100 nm PTFE powder 0.5 pbw | 6 nm Silica | 500 nm TiO₂ |
| | | 2.5 pbw | 900 nm PTFE powder 0.5 pbw | 2.5 pbw | 4.0 pbw |
| Example 19 | 0.8 | SA | 100 nm PTFE powder 0.5 pbw | 6 nm Silica | 800 nm TiO₂ |
| | | 3.0 pbw | 900 nm PTFE powder 0.5 pbw | 2.5 pbw | 2.0 pbw |
| Example 20 | 0.8 | SA | 100 nm PTFE powder 0.5 pbw | 6 nm Silica | 800 nm TiO₂ |
| | | 3.0 pbw | 900 nm PTFE powder 0.5 pbw | 2.5 pbw | 4.0 pbw |
| Example 21 | 0.8 | SA | 100 nm PTFE powder 0.5 pbw | 16 nm Silica | 500 nm TiO₂ |
| | | 3.0 pbw | 900 nm PTFE powder 0.5 pbw | 2.5 pbw | 2.0 pbw |
| Example 22 | 0.8 | SA | 100 nm PTFE powder 0.5 pbw | 16 nm Silica | 500 nm TiO₂ |
| | | 3.0 pbw | 900 nm PTFE powder 0.5 pbw | 2.5 pbw | 4.0 pbw |
| Example 23 | 0.8 | QAS | 100 nm PTFE powder 0.5 pbw | 16 nm Silica | 800 nm TiO₂ |
| | | 0.5 pbw | 900 nm PTFE powder 0.5 pbw | 2.5 pbw | 2.0 pbw |
| Example 24 | 0.8 | QAS | 100 nm PTFE powder 0.5 pbw | 16 nm Silica | 800 nm TiO₂ |
| | | 0.5 pbw | 900 nm PTFE powder 0.5 pbw | 2.5 pbw | 4.0 pbw |
| Example 25 | 0.8 | QAS | 100 nm PTFE powder 0.5 pbw | 6 nm Silica | 500 nm TiO₂ |
| | | 0.5 pbw | 900 nm PTFE powder 0.5 pbw | 3.5 pbw | 2.0 pbw |
| Example 26 | 0.8 | QAS | 100 nm PTFE powder 0.5 pbw | 6 nm Silica | 500 nm TiO₂ |
| | | 1.0 pbw | 900 nm PTFE powder 0.5 pbw | 3.5 pbw | 4.0 pbw |
| Example 27 | 0.8 | QAS | 100 nm PTFE powder 0.5 pbw | 6 nm Silica | 800 nm TiO₂ |
| | | 1.0 pbw | 900 nm PTFE powder 0.5 pbw | 3.5 pbw | 2.0 pbw |
| Example 28 | 0.8 | QAS | 100 nm PTFE powder 0.5 pbw | 6 nm Silica | 800 nm TiO₂ |
| | | 1.0 pbw | 900 nm PTFE powder 0.5 pbw | 3.5 pbw | 4.0 pbw |
| Example 29 | 0.8 | QAS | 100 nm PTFE powder 0.5 pbw | 16 nm Silica | 500 nm TiO₂ |
| | | 1.5 pbw | 900 nm PTFE powder 0.5 pbw | 3.5 pbw | 2.0 pbw |
| Example 30 | 0.8 | QAS | 100 nm PTFE powder 0.5 pbw | 16 nm Silica | 500 nm TiO₂ |
| | | 1.5 pbw | 900 nm PTFE powder 0.5 pbw | 3.5 pbw | 4.0 pbw |
| Example 31 | 0.8 | QAS | 100 nm PTFE powder 0.5 pbw | 16 nm Silica | 800 nm TiO₂ |
| | | 1.5 pbw | 900 nm PTFE powder 0.5 pbw | 3.5 pbw | 2.0 pbw |
| Example 32 | 0.8 | QAS | 100 nm PTFE powder 0.5 pbw | 16 nm Silica | 800 nm TiO₂ |
| | | 1.5 pbw | 900 nm PTFE powder 0.5 pbw | 3.5 pbw | 4.0 pbw |
| Example 33 | 0.6 | QAS | 70 nm PMMA powder 0.5 pbw | 6 nm Silica | 500 nm TiO₂ |
| | | 2.0 pbw | 700 nm PVDF powder 1.8 pbw | 2.5 pbw | 2.0 pbw |
| Example 34 | 0.6 | QAS | 70 nm PMMA powder 0.5 pbw | 6 nm Silica | 500 nm TiO₂ |
| | | 2.0 pbw | 700 nm PVDF powder 1.8 pbw | 2.5 pbw | 4.0 pbw |
| Example 35 | 0.6 | QAS | 70 nm PMMA powder 0.5 pbw | 6 nm Silica | 800 nm TiO₂ |
| | | 2.0 pbw | 700 nm PVDF powder 1.8 pbw | 2.5 pbw | 2.0 pbw |
| Example 36 | 0.6 | QAS | 70 nm PMMA powder 0.5 pbw | 6 nm Silica | 800 nm TiO₂ |
| | | 2.0 pbw | 700 nm PVDF powder 1.8 pbw | 2.5 pbw | 4.0 pbw |
| Example 37 | 0.6 | QAS | 70 nm PMMA powder 0.5 pbw | 6 nm Silica | 500 nm TiO₂ |
| | | 2.5 pbw | 700 nm PVDF powder 1.8 pbw | 2.5 pbw | 2.0 pbw |
| Example 38 | 0.6 | QAS | 70 nm PMMA powder 0.5 pbw | 16 nm Silica | 500 nm TiO₂ |
| | | 2.5 pbw | 700 nm PVDF powder 1.8 pbw | 3.5 pbw | 4.0 pbw |
| Example 39 | 0.6 | QAS | 70 nm PMMA powder 0.5 pbw | 16 nm Silica | 800 nm TiO₂ |
| | | 2.5 pbw | 700 nm PVDF powder 1.8 pbw | 3.5 pbw | 2.0 pbw |
| Example 40 | 0.6 | QAS | 70 nm PMMA powder 0.5 pbw | 16 nm Silica | 800 nm TiO₂ |
| | | 3.0 pbw | 700 nm PVDF powder 1.8 pbw | 3.5 pbw | 4.0 pbw |
| Example 41 | 0.6 | QAS | 70 nm PMMA powder 0.5 pbw | 16 nm Silica | 500 nm TiO₂ |
| | | 3.0 pbw | 700 nm PVDF powder 1.8 pbw | 3.5 pbw | 2.0 pbw |
| Example 42 | 0.6 | QAS | 70 nm PMMA powder 0.5 pbw | 16 nm Silica | 500 nm TiO₂ |
| | | 3.0 pbw | 700 nm PVDF powder 1.8 pbw | 3.5 pbw | 4.0 pbw |
| Example 43 | 0.6 | QAS | 70 nm PMMA powder 0.5 pbw | 16 nm Silica | 800 nm TiO₂ |
| | | 3.0 pbw | 700 nm PVDF powder 1.8 pbw | 3.5 pbw | 2.0 pbw |
| Example 44 | 0.6 | SMC | 70 nm PMMA powder 0.5 pbw | 16 nm Silica | 800 nm TiO₂ |
| | | 0.5 pbw | 700 nm PVDF powder 1.8 pbw | 3.5 pbw | 4.0 pbw |
| Example 45 | 0.6 | SMC | 70 nm PMMA powder 0.5 pbw | 16 nm Silica | 500 nm TiO₂ |
| | | 0.5 pbw | 700 nm PVDF powder 1.8 pbw | 3.5 pbw | 2.0 pbw |
| Example 46 | 0.6 | SMC | 70 nm PMMA powder 0.5 pbw | 16 nm Silica | 500 nm TiO₂ |
| | | 0.5 pbw | 700 nm PVDF powder 1.8 pbw | 3.5 pbw | 4.0 pbw |
| Example 47 | 0.6 | SMC | 70 nm PMMA powder 0.5 pbw | 16 nm Silica | 800 nm TiO₂ |
| | | 1.0 pbw | 700 nm PVDF powder 1.8 pbw | 3.5 pbw | 2.0 pbw |
| Example 48 | 0.6 | SMC | 70 nm PMMA powder 0.5 pbw | 16 nm Silica | 800 nm TiO₂ |
| | | 1.0 pbw | 700 nm PVDF powder 1.8 pbw | 3.5 pbw | 4.0 pbw |
| Example 49 | 0.8 | SMC | 110 nm PTFE powder 0.9 pbw | 6 nm Silica | 500 nm TiO₂ |
| | | 1.0 pbw | 900 nm PVDF powder 0.5 pbw | 2.5 pbw | 2.0 pbw |
| Example 50 | 0.8 | SMC | 110 nm PTFE powder 0.9 pbw | 6 nm Silica | 500 nm TiO₂ |
| | | 1.5 pbw | 900 nm PVDF powder 0.5 pbw | 2.5 pbw | 4.0 pbw |
| Example 51 | 0.8 | SMC | 110 nm PTFE powder 0.9 pbw | 6 nm Silica | 800 nm TiO₂ |
| | | 1.5 pbw | 900 nm PVDF powder 0.5 pbw | 2.5 pbw | 2.0 pbw |
| Example 52 | 0.8 | SMC | 110 nm PTFE powder 0.9 pbw | 6 nm Silica | 800 nm TiO₂ |
| | | 1.5 pbw | 900 nm PVDF powder 0.5 pbw | 2.5 pbw | 4.0 pbw |
| Example 53 | 0.8 | SMC | 110 nm PTFE powder 0.9 pbw | 6 nm Silica | 500 nm TiO₂ |
| | | 2.0 pbw | 900 nm PVDF powder 0.5 pbw | 2.5 pbw | 2.0 pbw |
| Example 54 | 0.8 | SMC | 110 nm PTFE powder 0.9 pbw | 16 nm Silica | 500 nm TiO₂ |
| | | 2.0 pbw | 900 nm PVDF powder 0.5 pbw | 3.5 pbw | 4.0 pbw |
| Example 55 | 0.8 | SMC | 110 nm PTFE powder 0.9 pbw | 16 nm Silica | 800 nm TiO₂ |
| | | 2.0 pbw | 900 nm PVDF powder 0.5 pbw | 3.5 pbw | 2.0 pbw |
| Example 56 | 0.8 | SMC | 110 nm PTFE powder 0.9 pbw | 16 nm Silica | 800 nm TiO₂ |
| | | 2.0 pbw | 900 nm PVDF powder 0.5 pbw | 3.5 pbw | 4.0 pbw |
| Example 57 | 0.8 | SMC | 110 nm PTFE powder 0.9 pbw | 16 nm Silica | 500 nm TiO₂ |
| | | 2.5 pbw | 900 nm PVDF powder 0.5 pbw | 3.5 pbw | 2.0 pbw |
| Example 58 | 0.8 | SMC | 110 nm PTFE powder 0.9 pbw | 16 nm Silica | 500 nm TiO₂ |
| | | 2.5 pbw | 900 nm PVDF powder 0.5 pbw | 3.5 pbw | 4.0 pbw |
| Example 59 | 0.8 | SMC | 110 nm PTFE powder 0.9 pbw | 16 nm Silica | 800 nm TiO₂ |
| | | 2.5 pbw | 900 nm PVDF powder 0.5 pbw | 3.5 pbw | 2.0 pbw |
| Example 60 | 0.8 | SMC | 110 nm PTFE powder 0.9 pbw | 16 nm Silica | 800 nm TiO₂ |
| | | 2.5 pbw | 900 nm PVDF powder 0.5 pbw | 3.5 pbw | 4.0 pbw |
| Example 61 | 0.8 | SMC | 110 nm PTFE powder 0.9 pbw | 16 nm Silica | 500 nm TiO₂ |
| | | 3.0 pbw | 900 nm PVDF powder 0.5 pbw | 3.5 pbw | 2.0 pbw |
| Example 62 | 0.8 | SMC | 110 nm PTFE powder 0.9 pbw | 16 nm Silica | 500 nm TiO₂ |
| | | 3.0 pbw | 900 nm PVDF powder 0.5 pbw | 3.5 pbw | 4.0 pbw |
| Example 63 | 0.8 | SMC | 110 nm PTFE powder 0.9 pbw | 16 nm Silica | 800 nm TiO₂ |
| | | 3.0 pbw | 900 nm PVDF powder 0.5 pbw | 3.5 pbw | 2.0 pbw |
| Example 64 | 0.8 | SMC | 110 nm PTFE powder 0.9 pbw | 16 nm Silica | 800 nm TiO₂ |
| | | 3.0 pbw | 900 nm PVDF powder 0.5 pbw | 3.5 pbw | 4.0 pbw |

* SA: styrene acrylate
QAS: Quaternary ammonium salt (benzyldimethyloctadecyl ammonium chloride)
SMC: salicylate metal complex (3,5-di-tert-butylsalicylate zinc complex)
pbw: parts by weight
PMMA: polymethylmethacrylate
PTFE: polytetrafluoroethylene
PVDF: polyvinylidene fluoride

### COMPARATIVE EXAMPLES 1˜63

Non-magnetic mono-component color toners were prepared in the same manner as in Example 1 except that spheroidization together with CCA was not performed (Comparative Example 1, 22, 43); or except by surface modifying with charge control agent and degree of spheroidization, and then coating with organic powders, silica, and titanium dioxide described in Table 2 below.

TABLE 2

| | Degree of | | First spherical organic powder | | |
|---|---|---|---|---|---|
| Section | spheroidization | CCA | Second spherical organic powder | Silica | TiO₂ |
| Comparative | 0.6 | — | 60 nm PMMA powder 0.8 pbw | 6 nm Silica | 500 nm TiO₂ |
| Example 1 | | | 800 nm PMMA powder 1.5 pbw | 2.5 pbw | 4.0 pbw |
| Comparative | 0.6 | SA | 60 nm PMMA powder 0.8 pbw | 6 nm Silica | 800 nm TiO₂ |
| Example 2 | | 0.3 pbw | 800 nm PMMA powder 1.5 pbw | 2.5 pbw | 2.0 pbw |
| Comparative | 0.6 | SA | 60 nm PMMA powder 0.8 pbw | 6 nm Silica | 800 nm TiO₂ |
| Example 3 | | 4.0 pbw | 800 nm PMMA powder 1.5 pbw | 2.5 pbw | 4.0 pbw |
| Comparative | 0.2 | SA | 60 nm PMMA powder 0.8 pbw | 16 nm Silica | 500 nm TiO₂ |
| Example 4 | | 1.0 pbw | 800 nm PMMA powder 1.5 pbw | 2.5 pbw | 2.0 pbw |
| Comparative | 1.0 | SA | 60 nm PMMA powder 0.8 pbw | 16 nm Silica | 500 nm TiO₂ |
| Example 5 | | 1.0 pbw | 800 nm PMMA powder 1.5 pbw | 2.5 pbw | 4.0 pbw |
| Comparative | 0.6 | SA | 30 nm PMMA powder 0.8 pbw | 16 nm Silica | 800 nm TiO₂ |
| Example 6 | | 1.0 pbw | 800 nm PMMA powder 1.5 pbw | 2.5 pbw | 2.0 pbw |
| Comparative | 0.6 | SA | 150 nm PMMA powder 0.8 pbw | 16 nm Silica | 800 nm TiO₂ |
| Example 7 | | 1.5 pbw | 800 nm PMMA powder 1.5 pbw | 2.5 pbw | 4.0 pbw |
| Comparative | 0.6 | SA | 60 nm PMMA powder 0.1 pbw | 6 nm Silica | 500 nm TiO₂ |
| Example 8 | | 1.5 pbw | 800 nm PMMA powder 1.5 pbw | 3.5 pbw | 2.0 pbw |
| Comparative | 0.6 | SA | 60 nm PMMA powder 1.5 pbw | 6 nm Silica | 500 nm TiO₂ |
| Example 9 | | 1.5 pbw | 800 nm PMMA powder 1.5 pbw | 3.5 pbw | 4.0 pbw |
| Comparative | 0.6 | SA | 60 nm PMMA powder 0.8 pbw | 6 nm Silica | 800 nm TiO₂ |
| Example 10 | | 2.0 pbw | 300 nm PMMA powder 1.5 pbw | 3.5 pbw | 2.0 pbw |
| Comparative | 0.6 | SA | 60 nm PMMA powder 0.8 pbw | 6 nm Silica | 800 nm TiO₂ |
| Example 11 | | 2.0 pbw | 1500 nm PMMA powder 1.5 pbw | 3.5 pbw | 4.0 pbw |
| Comparative | 0.6 | SA | 60 nm PMMA powder 0.8 pbw | 16 nm Silica | 500 nm TiO₂ |
| Example 12 | | 2.0 pbw | 800 nm PMMA powder 3.0 pbw | 3.5 pbw | 2.0 pbw |
| Comparative | 0.6 | SA | 60 nm PMMA powder 0.8 pbw | 16 nm Silica | 500 nm TiO₂ |
| Example 13 | | 2.0 pbw | 800 nm PMMA powder 0.1 pbw | 3.5 pbw | 4.0 pbw |
| Comparative | 0.6 | SA | 60 nm PMMA powder 0.8 pbw | 1 nm Silica | 800 nm TiO₂ |
| Example 14 | | 2.5 pbw | 800 nm PMMA powder 1.5 pbw | 3.5 pbw | 2.0 pbw |
| Comparative | 0.6 | SA | 60 nm PMMA powder 0.8 pbw | 30 nm Silica | 800 nm TiO₂ |
| Example 15 | | 2.5 pbw | 800 nm PMMA powder 1.5 pbw | 3.5 pbw | 4.0 pbw |
| Comparative | 0.8 | SA | 100 nm PTFE powder 0.5 pbw | 6 nm Silica | 500 nm TiO₂ |
| Example 16 | | 2.5 pbw | 900 nm PTFE powder 0.5 pbw | 0.5 pbw | 2.0 pbw |
| Comparative | 0.8 | SA | 100 nm PTFE powder 0.5 pbw | 6 nm Silica | 500 nm TiO₂ |
| Example 17 | | 2.5 pbw | 900 nm PTFE powder 0.5 pbw | 5.0 pbw | 4.0 pbw |
| Comparative | 0.8 | SA | 100 nm PTFE powder 0.5 pbw | 6 nm Silica | 200 nm TiO₂ |
| Example 18 | | 3.0 pbw | 900 nm PTFE powder 0.5 pbw | 2.5 pbw | 2.0 pbw |
| Comparative | 0.8 | SA | 100 nm PTFE powder 0.5 pbw | 6 nm Silica | 1200 nm TiO₂ |
| Example 19 | | 3.0 pbw | 900 nm PTFE powder 0.5 pbw | 2.5 pbw | 4.0 pbw |
| Comparative | 0.8 | SA | 100 nm PTFE powder 0.5 pbw | 16 nm Silica | 500 nm TiO₂ |
| Example 20 | | 3.0 pbw | 900 nm PTFE powder 0.5 pbw | 2.5 pbw | 1.0 pbw |
| Comparative | 0.8 | SA | 100 nm PTFE powder 0.5 pbw | 16 nm Silica | 500 nm TiO₂ |
| Example 21 | | 3.0 pbw | 900 nm PTFE powder 0.5 pbw | 2.5 pbw | 5.0 pbw |
| Comparative | 0.8 | — | 100 nm PTFE powder 0.5 pbw | 16 nm Silica | 800 nm TiO₂ |
| Example 22 | | | 900 nm PTFE powder 0.5 pbw | 2.5 pbw | 2.0 pbw |
| Comparative | 0.8 | QAS | 100 nm PTFE powder 0.5 pbw | 16 nm Silica | 800 nm TiO₂ |
| Example 23 | | 0.3 pbw | 900 nm PTFE powder 0.5 pbw | 2.5 pbw | 4.0 pbw |
| Comparative | 0.8 | QAS | 100 nm PTFE powder 0.5 pbw | 6 nm Silica | 500 nm TiO₂ |
| Example 24 | | 4.0 pbw | 900 nm PTFE powder 0.5 pbw | 3.5 pbw | 2.0 pbw |
| Comparative | 0.2 | QAS | 100 nm PTFE powder 0.5 pbw | 6 nm Silica | 500 nm TiO₂ |
| Example 25 | | 1.0 pbw | 900 nm PTFE powder 0.5 pbw | 3.5 pbw | 4.0 pbw |
| Comparative | 1.0 | QAS | 100 nm PTFE powder 0.5 pbw | 6 nm Silica | 800 nm TiO₂ |
| Example 26 | | 1.0 pbw | 900 nm PTFE powder 0.5 pbw | 3.5 pbw | 2.0 pbw |
| Comparative | 0.8 | QAS | 30 nm PTFE powder 0.5 pbw | 6 nm Silica | 800 nm TiO₂ |
| Example 27 | | 1.0 pbw | 900 nm PTFE powder 0.5 pbw | 3.5 pbw | 4.0 pbw |
| Comparative | 0.8 | QAS | 150 nm PTFE powder 0.5 pbw | 16 nm Silica | 500 nm TiO₂ |
| Example 28 | | 1.5 pbw | 900 nm PTFE powder 0.5 pbw | 3.5 pbw | 2.0 pbw |
| Comparative | 0.8 | QAS | 100 nm PTFE powder 0.1 pbw | 16 nm Silica | 500 nm TiO₂ |
| Example 29 | | 1.5 pbw | 900 nm PTFE powder 0.5 pbw | 3.5 pbw | 4.0 pbw |
| Comparative | 0.8 | QAS | 100 nm PTFE powder 1.5 pbw | 16 nm Silica | 800 nm TiO₂ |
| Example 30 | | 1.5 pbw | 900 nm PTFE powder 0.5 pbw | 3.5 pbw | 2.0 pbw |
| Comparative | 0.8 | QAS | 100 nm PTFE powder 0.5 pbw | 16 nm Silica | 800 nm TiO₂ |
| Example 31 | | 1.5 pbw | 300 nm PTFE powder 0.5 pbw | 3.5 pbw | 4.0 pbw |
| Comparative | 0.6 | QAS | 70 nm PMMA powder 0.5 pbw | 6 nm Silica | 500 nm TiO₂ |
| Example 32 | | 2.0 pbw | 1500 nm PVDF powder 1.8 pbw | 2.5 pbw | 2.0 pbw |
| Comparative | 0.6 | QAS | 70 nm PMMA powder 0.5 pbw | 6 nm Silica | 500 nm TiO₂ |
| Example 33 | | 2.0 pbw | 700 nm PVDF powder 3.0 pbw | 2.5 pbw | 4.0 pbw |
| Comparative | 0.6 | QAS | 70 nm PMMA powder 0.5 pbw | 6 nm Silica | 800 nm TiO₂ |
| Example 34 | | 2.0 pbw | 700 nm PVDF powder 0.1 pbw | 2.5 pbw | 2.0 pbw |
| Comparative | 0.6 | QAS | 70 nm PMMA powder 0.5 pbw | 1 nm Silica | 800 nm TiO₂ |
| Example 35 | | 2.0 pbw | 700 nm PVDF powder 1.8 pbw | 2.5 pbw | 4.0 pbw |
| Comparative | 0.6 | QAS | 70 nm PMMA powder 0.5 pbw | 30 nm Silica | 500 nm TiO₂ |
| Example 36 | | 2.5 pbw | 700 nm PVDF powder 1.8 pbw | 2.5 pbw | 2.0 pbw |
| Comparative | 0.6 | QAS | 70 nm PMMA powder 0.5 pbw | 16 nm Silica | 500 nm TiO₂ |
| Example 37 | | 2.5 pbw | 700 nm PVDF powder 1.8 pbw | 0.5 pbw | 4.0 pbw |
| Comparative | 0.6 | QAS | 70 nm PMMA powder 0.5 pbw | 16 nm Silica | 800 nm TiO₂ |
| Example 38 | | 2.5 pbw | 700 nm PVDF powder 1.8 pbw | 5.0 pbw | 2.0 pbw |
| Comparative | 0.6 | QAS | 70 nm PMMA powder 0.5 pbw | 16 nm Silica | 200 nm TiO₂ |
| Example 39 | | 3.0 pbw | 700 nm PVDF powder 1.8 pbw | 3.5 pbw | 4.0 pbw |
| Comparative | 0.6 | QAS | 70 nm PMMA powder 0.5 pbw | 16 nm Silica | 1200 nm TiO₂ |
| Example 40 | | 3.0 pbw | 700 nm PVDF powder 1.8 pbw | 3.5 pbw | 2.0 pbw |
| Comparative | 0.6 | QAS | 70 nm PMMA powder 0.5 pbw | 16 nm Silica | 500 nm TiO₂ |
| Example 41 | | 3.0 pbw | 700 nm PVDF powder 1.8 pbw | 3.5 pbw | 1.0 pbw |
| Comparative | 0.6 | QAS | 70 nm PMMA powder 0.5 pbw | 16 nm Silica | 800 nm TiO₂ |
| Example 42 | | 3.0 pbw | 700 nm PVDF powder 1.8 pbw | 3.5 pbw | 5.0 pbw |
| Comparative | 0.6 | — | 70 nm PMMA powder 0.5 pbw | 16 nm Silica | 800 nm TiO₂ |
| Example 43 | | | 700 nm PVDF powder 1.8 pbw | 3.5 pbw | 4.0 pbw |
| Comparative | 0.6 | SMC | 70 nm PMMA powder 0.5 pbw | 16 nm Silica | 500 nm TiO₂ |
| Example 44 | | 0.3 pbw | 700 nm PVDF powder 1.8 pbw | 3.5 pbw | 2.0 pbw |
| Comparative | 0.6 | SMC | 70 nm PMMA powder 0.5 pbw | 16 nm Silica | 500 nm TiO₂ |
| Example 45 | | 4.0 pbw | 700 nm PVDF powder 1.8 pbw | 3.5 pbw | 4.0 pbw |
| Comparative | 0.2 | SMC | 70 nm PMMA powder 0.5 pbw | 16 nm Silica | 800 nm TiO₂ |
| Example 46 | | 1.0 pbw | 700 nm PVDF powder 1.8 pbw | 3.5 pbw | 2.0 pbw |
| Comparative | 1.0 | SMC | 70 nm PMMA powder 0.5 pbw | 16 nm Silica | 800 nm TiO₂ |
| Example 47 | | 1.0 pbw | 700 nm PVDF powder 1.8 pbw | 3.5 pbw | 4.0 pbw |
| Comparative | 0.8 | SMC | 30 nm PTFE powder 0.9 pbw | 6 nm Silica | 500 nm TiO₂ |
| Example 48 | | 1.0 pbw | 900 nm PVDF powder 0.5 pbw | 2.5 pbw | 2.0 pbw |
| Comparative | 0.8 | SMC | 150 nm PTFE powder 0.9 pbw | 6 nm Silica | 500 nm TiO₂ |
| Example 49 | | 1.5 pbw | 900 nm PVDF powder 0.5 pbw | 2.5 pbw | 4.0 pbw |
| Comparative | 0.8 | SMC | 110 nm PTFE powder 0.1 pbw | 6 nm Silica | 800 nm TiO₂ |
| Example 50 | | 1.5 pbw | 900 nm PVDF powder 0.5 pbw | 2.5 pbw | 2.0 pbw |
| Comparative | 0.8 | SMC | 110 nm PTFE powder 1.5 pbw | 6 nm Silica | 800 nm TiO₂ |
| Example 51 | | 1.5 pbw | 900 nm PVDF powder 0.5 pbw | 2.5 pbw | 4.0 pbw |
| Comparative | 0.8 | SMC | 110 nm PTFE powder 0.9 pbw | 6 nm Silica | 500 nm TiO₂ |
| Example 52 | | 2.0 pbw | 300 nm PVDF powder 0.5 pbw | 2.5 pbw | 2.0 pbw |
| Comparative | 0.8 | SMC | 110 nm PTFE powder 0.9 pbw | 16 nm Silica | 500 nm TiO₂ |
| Example 53 | | 2.0 pbw | 1500 nm PVDF powder 0.5 pbw | 3.5 pbw | 4.0 pbw |
| Comparative | 0.8 | SMC | 110 nm PTFE powder 0.9 pbw | 16 nm Silica | 800 nm TiO₂ |
| Example 54 | | 2.0 pbw | 900 nm PVDF powder 3.0 pbw | 3.5 pbw | 2.0 pbw |
| Comparative | 0.8 | SMC | 110 nm PTFE powder 0.9 pbw | 16 nm Silica | 800 nm TiO₂ |
| Example 55 | | 2.0 pbw | 900 nm PVDF powder 0.1 pbw | 3.5 pbw | 4.0 pbw |
| Comparative | 0.8 | SMC | 110 nm PTFE powder 0.9 pbw | 1 nm Silica | 500 nm TiO₂ |
| Example 56 | | 2.5 pbw | 900 nm PVDF powder 0.5 pbw | 3.5 pbw | 2.0 pbw |
| Comparative | 0.8 | SMC | 110 nm PTFE powder 0.9 pbw | 30 nm Silica | 500 nm TiO₂ |
| Example 57 | | 2.5 pbw | 900 nm PVDF powder 0.5 pbw | 3.5 pbw | 4.0 pbw |
| Comparative | 0.8 | SMC | 110 nm PTFE powder 0.9 pbw | 16 nm Silica | 800 nm TiO₂ |
| Example 58 | | 2.5 pbw | 900 nm PVDF powder 0.5 pbw | 0.5 pbw | 2.0 pbw |
| Comparative | 0.8 | SMC | 110 nm PTFE powder 0.9 pbw | 16 nm Silica | 800 nm TiO₂ |
| Example 59 | | 2.5 pbw | 900 nm PVDF powder 0.5 pbw | 5.0 pbw | 4.0 pbw |
| Comparative | 0.8 | SMC | 110 nm PTFE powder 0.9 pbw | 16 nm Silica | 200 nm TiO₂ |
| Example 60 | | 3.0 pbw | 900 nm PVDF powder 0.5 pbw | 3.5 pbw | 2.0 pbw |
| Comparative | 0.8 | SMC | 110 nm PTFE powder 0.9 pbw | 16 nm Silica | 1200 nm TiO₂ |
| Example 61 | | 3.0 pbw | 900 nm PVDF powder 0.5 pbw | 3.5 pbw | 4.0 pbw |
| Comparative | 0.8 | SMC | 110 nm PTFE powder 0.9 pbw | 16 nm Silica | 800 nm TiO₂ |
| Example 62 | | 3.0 pbw | 900 nm PVDF powder 0.5 pbw | 3.5 pbw | 1.0 pbw |
| Comparative | 0.8 | SMC | 110 nm PTFE powder 0.9 pbw | 16 nm Silica | 800 nm TiO₂ |
| Example 63 | | 3.0 pbw | 900 nm PVDF powder 0.5 pbw | 3.5 pbw | 5.0 pbw |

* SA: styrene acrylate
QAS: Quaternary ammonium salt (benzyldimethyloctadecyl ammonium chloride)
SMC: salicylate metal complex (3,5-di-tert-butylsalicylate zinc complex)
pbw: parts by weight
PMMA: polymethylmethacrylate
PTFE: polytetrafluoroethylene
PVDF: polyvinylidene fluoride

### EXPERIMENTAL EXAMPLE 1

The color toners prepared in Examples 1-64 and Comparative Examples 1-63 were evaluated for image density, image contamination, transfer efficiency, long-term stability, and background contamination, according to printing conditions by printing 3,000 sheets using a commercially available non-magnetic mono-component developing printer (HP2600, Hewlett-Packard) employing a contact type developing mode as follows. The results are summarized in Tables 3 and 4 below.

1) Image Density

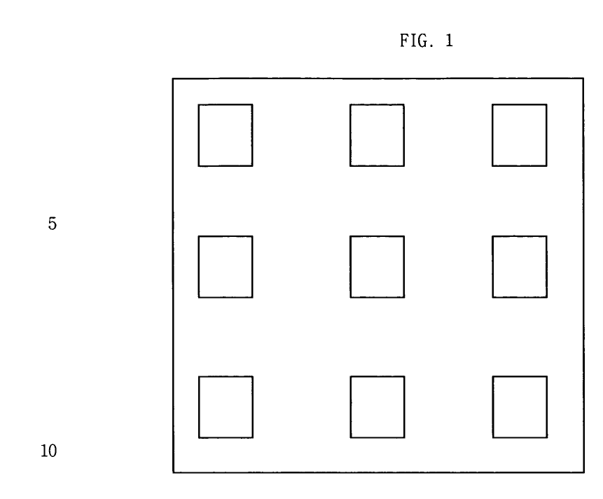

Toner densities of nine points of a solid area image, as shown in FIG. 1, were measured, and their average value was defined as an image density that is a critical factor for determining a long-term image maintenance capability.

The image density measurement was performed by a Macbeth Reflective Densitometer (RD918) and evaluated based on the following four grades:

A: Image density is greater than 1.30

B: Image density is 1.0˜1.3

C: Image density is 0.5˜1.0

D: Image density is less than 0.5

After printing 3,000 sheets, 1,000 sheets were sampled for each toner prepared in Examples 1-64 and Comparative Examples 1-63.

2) Image Contamination

Image contamination was evaluated based on primary charge roller (PCR) contamination as follows.

A: no PCR contamination

B: slight PCR contamination

C: much PCR contamination

D: severe PCR contamination

3) Transfer Efficiency

The percentage (%) of toner purely transferred to a sheet was measured for 500 printouts (for each toner prepared in Examples 1-64 and Comparative Examples 1-63) by calculating an amount of each toner used (toner net weight−toner waste amount).

A: Transfer efficiency is greater than 80%

B: Transfer efficiency is 70□80%

C: Transfer efficiency is 60□70%

D: Transfer efficiency is 50□60%

4) Long-Term Stability

Long-term stability was evaluated by investigating whether or not an image density (I.D.) and transfer efficiency were maintained until 3,000 sheets were printed.

A: I.D. of 1.4 or more, transfer efficiency of 75% or more in 3,000 printouts

B: I.D. of 1.3 or more, transfer efficiency of 70% or more in 3,000 printouts

C: I.D. of 1.2 or less, transfer efficiency of 60% or more in 3,000 printouts

D: I.D. of 1.0 or less, transfer efficiency of 40% or more in 3,000 printouts

5) Background Contamination

Toner particles may contaminate non-image areas during printing, and the degree of contamination on non-image areas was evaluated. For this, toner densities of non-image areas were measured to compare the degree of contamination on the non-image areas for the toners prepared in Examples 1-64 and Comparative Examples 1-63.

White papers with no image were printed out. Toner densities on nine points as shown in FIG. 1 were measured by a Macbeth Reflective Densitometer (RD918) and their average value was calculated

A: Toner density of non-image areas is less than 0.01

B: Toner density of non-image areas is 0.01˜0.03

C: Toner density of non-image areas is 0.03˜0.08

D: Toner density of non-image areas is greater than 0.08

After printing 3,000 sheets, 1,000 sheets were sampled for each toner prepared in Examples 1-64 and Comparative Examples 1-63.

TABLE 3

| | | | Image | | Long- |
|---|---|---|---|---|---|
| | Background | Image | contami- | Transfer | term |
| Section | contamination | density | nation | efficiency | stability |
| Example 1 | A | A | A | A | A |
| Example 2 | A | A | A | A | A |
| Example 3 | A | A | A | A | A |
| Example 4 | A | A | A | A | A |
| Example 5 | A | A | A | A | A |
| Example 6 | A | A | A | A | A |
| Example 7 | A | A | A | A | A |
| Example 8 | A | A | A | A | A |
| Example 9 | A | A | A | A | A |
| Example 10 | A | A | A | A | A |
| Example 11 | A | A | A | A | A |
| Example 12 | A | A | A | A | A |
| Example 13 | A | A | A | A | A |
| Example 14 | A | A | A | A | A |
| Example 15 | A | B | A | A | A |
| Example 16 | A | A | A | A | A |
| Example 17 | A | A | A | A | A |
| Example 18 | A | A | A | A | A |
| Example 19 | A | A | A | A | A |
| Example 20 | A | A | A | A | A |
| Example 21 | A | A | A | A | A |
| Example 22 | A | A | A | A | A |
| Example 23 | A | A | A | A | A |
| Example 24 | A | A | A | A | A |
| Example 25 | A | A | A | A | A |
| Example 26 | A | A | A | A | A |
| Example 27 | A | A | A | A | A |
| Example 28 | A | A | A | A | A |
| Example 29 | A | A | A | A | A |
| Example 30 | A | A | A | A | A |
| Example 31 | A | A | A | A | A |
| Example 32 | A | A | A | A | A |
| Example 33 | A | A | A | A | A |
| Example 34 | A | A | A | A | A |
| Example 35 | A | A | A | A | A |
| Example 36 | A | A | A | A | A |
| Example 37 | A | A | A | A | A |
| Example 38 | A | A | A | A | A |
| Example 39 | A | A | A | A | A |
| Example 40 | A | A | A | A | A |
| Example 41 | A | A | A | A | A |
| Example 42 | A | A | A | A | A |
| Example 43 | A | A | A | A | A |
| Example 44 | A | A | A | A | A |
| Example 45 | A | A | A | A | A |
| Example 46 | A | A | A | A | A |
| Example 47 | A | A | A | A | A |
| Example 48 | A | A | A | A | A |
| Example 49 | A | A | A | A | A |
| Example 50 | A | A | A | A | A |
| Example 52 | A | A | A | A | A |
| Example 53 | A | A | A | A | A |
| Example 54 | A | A | A | A | A |
| Example 55 | A | A | A | A | A |
| Example 56 | A | A | A | A | A |
| Example 57 | A | A | A | A | A |
| Example 58 | A | A | A | A | A |
| Example 59 | A | A | A | A | A |
| Example 60 | A | A | A | A | A |
| Example 61 | A | A | A | A | A |
| Example 62 | A | A | A | A | A |
| Example 63 | A | A | A | A | A |
| Example 64 | A | A | A | A | A |

TABLE 4

| | Background | | Image | Transfer | Long-term |
|---|---|---|---|---|---|
| Section | contamination | Image density | contamination | efficiency | stability |
| Comparative Example 1 | D | D | D | D | D |
| Comparative Example 2 | D | D | D | D | D |
| Comparative Example 3 | D | D | D | D | D |
| Comparative Example 4 | D | D | D | D | D |
| Comparative Example 5 | D | D | D | D | D |
| Comparative Example 6 | D | D | D | D | D |
| Comparative Example 7 | D | D | D | D | D |
| Comparative Example 8 | D | D | D | D | D |
| Comparative Example 9 | D | D | C | D | D |
| Comparative Example 10 | D | D | D | D | C |
| Comparative Example 11 | D | D | D | D | D |
| Comparative Example 12 | D | D | D | D | D |
| Comparative Example 13 | D | D | D | D | D |
| Comparative Example 14 | D | C | D | D | D |
| Comparative Example 15 | D | D | D | D | C |
| Comparative Example 16 | D | D | D | D | D |
| Comparative Example 17 | D | D | D | D | D |
| Comparative Example 18 | D | D | D | D | D |
| Comparative Example 19 | D | D | D | D | D |
| Comparative Example 20 | D | D | D | D | D |
| Comparative Example 21 | D | D | D | D | C |
| Comparative Example 22 | D | D | D | D | D |
| Comparative Example 23 | D | D | D | D | D |
| Comparative Example 24 | D | D | D | D | D |
| Comparative Example 25 | D | D | D | D | D |
| Comparative Example 26 | D | D | D | D | D |
| Comparative Example 27 | D | C | D | D | D |
| Comparative Example 28 | D | D | D | D | D |
| Comparative Example 29 | D | D | D | D | D |
| Comparative Example 30 | D | D | D | D | D |
| Comparative Example 31 | D | C | D | D | D |
| Comparative Example 32 | D | D | D | D | D |
| Comparative Example 33 | D | D | D | D | D |
| Comparative Example 34 | D | D | D | D | D |
| Comparative Example 35 | D | D | D | D | D |
| Comparative Example 36 | D | D | D | D | D |
| Comparative Example 37 | D | D | D | D | D |
| Comparative Example 38 | D | D | D | D | C |
| Comparative Example 39 | D | D | D | D | D |
| Comparative Example 40 | D | D | D | D | D |
| Comparative Example 41 | D | D | D | D | D |
| Comparative Example 42 | D | D | D | D | D |
| Comparative Example 43 | D | D | D | D | D |
| Comparative Example 44 | D | D | D | D | D |
| Comparative Example 45 | D | D | D | D | D |
| Comparative Example 46 | D | C | D | D | D |
| Comparative Example 47 | D | D | D | D | D |
| Comparative Example 47 | D | D | D | D | D |
| Comparative Example 48 | D | D | D | D | D |
| Comparative Example 49 | D | D | D | D | D |
| Comparative Example 50 | D | D | D | D | D |
| Comparative Example 51 | D | D | D | D | C |
| Comparative Example 52 | D | D | D | D | D |
| Comparative Example 53 | D | D | D | D | D |
| Comparative Example 54 | D | D | D | D | D |
| Comparative Example 55 | D | D | D | D | D |
| Comparative Example 56 | D | D | D | D | C |
| Comparative Example 57 | D | D | D | D | D |
| Comparative Example 58 | D | D | D | D | D |
| Comparative Example 59 | D | D | D | D | D |
| Comparative Example 60 | D | D | D | D | D |
| Comparative Example 61 | D | D | D | D | D |
| Comparative Example 62 | D | D | D | D | D |
| Comparative Example 63 | D | D | D | D | D |

As shown in Tables 3 and 4, the color toners prepared in Examples 1-64 wherein toner core particles were spheroidized to a predetermined level during surface modification with a predetermined amount of a CCA and then coated with spherical organic powders having different particle sizes, silica, and titanium dioxide were significantly improved in terms of background contamination, image density, image contamination, transfer efficiency, and long-term stability, as compared with the color toners prepared in Comparative Examples 1-63 wherein toner core particles were surface-modified by the content of a CCA and the degree of spheroidization outside the inventive ranges and coated with the different particles from those in present invention.

As described above, the inventive color toner exhibits improved charge properties by surface modification of toner core particles with a predetermined amount of a CCA during spheroidization, followed by coating with external additives. That is, the inventive non-magnetic mono-component color toner exhibits high chargeability and good long-term charge uniformity, thereby ensuring improved transfer efficiency, long-term stability, and background contamination.

What is claimed is:

1. A non-magnetic mono-component color toner comprising spherical toner core particles surface-modified with a charge control agent.

2. The non-magnetic mono-component color toner of claim 1, wherein the toner core particles are further surface-coated with a first spherical organic powder with an average particle size of 50 to 120 nm; a second spherical organic powder with an average particle size of 600 to 1,000 nm; silica with an average particle size of 5 to 20 nm; and titanium dioxide with an average particle size of 300 to 1,000 nm.

3. The non-magnetic mono-component color toner of claim 2, wherein the first spherical organic powder, the second spherical organic powder, the silica, and the titanium dioxide are respectively used in an amount of 0.4 to 1.0 part by weight, 0.4 to 2.0 parts by weight, 1.0 to 4.0 parts by weight, and 1.5 to 4.0 parts by weight, based on 100 parts by weight of the toner core particles.

4. The non-magnetic mono-component color toner of claim 2, wherein each of the first and second spherical organic powders is a polymer of at least one monomer selected from the group consisting of styrenes, vinyl halides, vinyl esters, methacrylates, acrylic acid derivatives, acrylates, and dienes.

5. The non-magnetic mono-component color toner of claim 1, wherein the degree of spheroidization of the toner core particles is 0.5 to 0.8.

6. The non-magnetic mono-component color toner of claim 1, wherein the charge control agent is selected from the group consisting of chromium-containing azo metal complexes, salicylate metal complexes, chromium-containing organic dyes, quaternary ammonium salts, and styrene acrylic resins.

7. The non-magnetic mono-component color toner of claim 6, wherein the charge control agent is selected from the group consisting of salicylate metal complexes and styrene acrylic resins.

8. The non-magnetic mono-component color toner of claim 1, wherein the charge control agent is used in an amount of 0.5 to 3.0 parts by weight, based on 100 parts by weight of the toner core particles.

9. The non-magnetic mono-component color toner of claim 1, which has an average particle size of 3-10 μm.

10. The non-magnetic mono-component color toner of claim 1, wherein the toner core particles comprise a binder resin and a colorant.

11. The non-magnetic mono-component color toner of claim 10, wherein the binder resin is at least one selected from the group consisting of polystyrene resins, polyester resins, polyethylene resins, polypropylene resins, styrene-alkyl acrylate copolymers, styrene-alkyl methacrylate copolymers, styrene-acrylonitrile copolymers, styrene-butadiene copolymers, and styrene-maleic acid copolymers.

12. The non-magnetic mono-component color toner of claim 10, wherein the colorant is at least one selected from the group consisting of nigrosine dye, aniline blue, charcoal blue, chrome yellow, ultramarine blue, Dupont oil red, methylene blue chloride, phthalocyanine blue, lamp black, rose bengal, C.I. pigment red 48:1, C.I. pigment red 48:4, C.I. pigment red 122, C.I. pigment red 57:1, C.I. pigment red 257, C.I. pigment red 296, C.I. pigment yellow 97, C.I. pigment yellow 12, C.I. pigment yellow 17, C.I. pigment yellow 14, C.I. pigment yellow 13, C.I. pigment yellow 16, C.I. pigment yellow 81, C.I. pigment yellow 126, C.I. pigment yellow 127, C.I. pigment blue 9, C.I. pigment blue 15, C.I. pigment blue 15:1, and C.I. pigment blue 15:3.

13. A method of preparing a non-magnetic mono-component color toner, the method comprising:
spheroidizing toner core particles in the presence of a charge control agent; and
coating the surfaces of the resultant spherical toner core particles with a first spherical organic powder with an average particle size of 50 to 120 nm, a second spherical organic powder with an average particle size of 600 to 1,000 nm, silica with an average particle size of 5 to 20 nm, and titanium dioxide with an average particle size of 300 to 1,000 nm.

14. The method of claim 13, wherein the charge control agent is used in an amount of 0.5 to 3.0 parts by weight, based on 100 parts by weight of the toner core particles.

15. The method of claim 13, wherein the spheroidization of the toner core particles is performed using a mechanical or thermal process.
